(19) United States
(12) Patent Application Publication
(10) Pub. No.: US 2017/0109501 A1
(43) Pub. Date: Apr. 20, 2017

(54) SYSTEM AND METHODS FOR ASSESSING PATIENT ABILITY FOR SHARED-DECISION MAKING

(71) Applicant: Expert Medical Navigation, Fall River, MA (US)

(72) Inventor: Ibrahim Eid, Tiverton, RI (US)

(73) Assignee: Expert Medical Navigation, Fall River, MA (US)

(21) Appl. No.: 15/293,699

(22) Filed: Oct. 14, 2016

Related U.S. Application Data
(60) Provisional application No. 62/242,868, filed on Oct. 16, 2015.

(51) Int. Cl. G06F 19/00; G09B 7/06

(52) U.S. Cl. CPC G06F 19/3487; G06F 19/322; G09B 7/06

(57) ABSTRACT

A computer-implemented system for assessing the ability of a patient to participate in a shared decision making process with a clinician is provided. The system may include a user interface configured to receive, from a patient, user input indicative of responses to questions of a questionnaire. The user interface may present, to the patient, educational content associated with a medical condition of the patient. The system may include one or more processors configured to receive data indicative of the patient's responses before and after the patient is presented with the educational content. The system may include one or more storage media storing processor-executable instructions that, when executed by the one or more processors perform a method. The method may include generating one or more scores based on the patient's responses and generating an indication of the patient's ability to participate in the shared decision making process with the clinician based on the one or more scores.

### RELATED APPLICATIONS

The present application claims the benefit under 35 U.S.C. §119(e) of U.S. Provisional Patent Application Ser. No. 62/242,868 entitled “SYSTEM AND METHODS FOR ASSESSING PATIENT ABILITY FOR SHARED-DECISION MAKING,” filed Oct. 16, 2015, which is incorporated herein by reference in its entirety.

### BACKGROUND

Field

The present application relates to techniques for assessing a patient's ability to participate in shared decision making (SDM).

Related Art

Decision-making processes between clinicians and patients include discussing a patient's medical condition and treatment options for the medical condition. Patients that are more knowledgeable about their medical condition and treatment options may contribute to these discussions in a more effective manner than patients that lack such knowledge.

### SUMMARY

According to an aspect of the present application, a computer-implemented system for assessing the ability of a patient to participate in a shared decision making process with a clinician is provided. The computer-implemented system comprises a user interface, at least one processor, and at least one storage medium. The user interface is configured to receive, from the patient, user input indicative of a first set of responses to questions of a questionnaire over a first time duration and present, to the patient, educational content associated with a medical condition of the patient. The user interface is further configured to receive, from the patient, user input indicative of a second set of responses to questions of the questionnaire over a second time duration, wherein the second time duration occurs at a time after the educational content is presented. The at least one processor is configured to receive data indicative of the first and second set of responses. The at least one storage medium is configured to store processor-executable instructions that, when executed by the at least one processor, perform a method. The method comprises generating a first score based on the first set of responses and a second score based on the second set of responses and generating an indication of the patient's ability to participate in the shared decision making process with a clinician based on the first and second scores.

In some embodiments, generating the indication of the patient's ability to participate in the shared decision making process further comprises determining a confidence level of the patient's understanding of the medical condition based at least in part on the patient's responses to at least a portion of the questions of the questionnaire. In some embodiments, generating the indication of the patient's ability to participate in the shared decision making process further comprises determining a confidence level of the patient's understanding of treatment options for the medical condition based at least in part on the patient's responses to at least a portion of the questions of the questionnaire. In some embodiments, the user interface is further configured to present itemized answer options for at least a portion of the questions of the questionnaire. In some embodiments, the method further comprises selecting the educational content based on patient information associated with the patient. In some embodiments, the patient information includes an electronic medical record of the patient. In some embodiments, the method further comprises selecting the educational content based on information provided by a clinician via a second user interface. In some embodiments, generating the indication of the patient's ability to participate in the shared decision making process further comprises comparing the first score and the second score to identify whether there was a change in a confidence level of the patient. In some embodiments, comparing the first score and the second score comprises determining a difference between the first score and the second score. In some embodiments, the system further comprises a second user interface configured to present the indication of the patient's ability to participate in the shared decision making process to a clinician.

According to an aspect of the present application, a method for assessing the ability of a patient to participate in a shared decision making process with a clinician is provided. The method comprises receiving, from the patient, user input indicative of a first set of responses to questions of a questionnaire over a first time duration. The method further comprises presenting, to the patient, educational content associated with a medical condition of the patient. The method further comprises receiving, from the patient, user input indicative of a second set of responses to questions of the questionnaire over a second time duration. The second time duration occurs at a time after the educational content is presented. The method further comprises generating a first score based on the first set of responses and a second score based on the second set of responses. The method further comprises generating an indication of the patient's ability to participate in the shared decision making process with a clinician based on the first and second scores.

In some embodiments, generating the indication of the patient's ability to participate in the shared decision making process further comprises determining a confidence level of the patient's understanding of the medical condition based at least in part on the patient's responses to at least a portion of the questions of the questionnaire. In some embodiments, generating the indication of the patient's ability to participate in the shared decision making process further comprises determining a confidence level of the patient's understanding of treatment options for the medical condition based at least in part on the patient's responses to at least a portion of the questions of the questionnaire. In some embodiments, the method further comprises presenting itemized answer options for at least a portion of the questions of the questionnaire. In some embodiments, the method further comprises selecting the educational content based on patient information associated with the patient. In some embodiments, the patient information includes an electronic medical record of the patient. In some embodiments, the method further comprises selecting the educational content based on information provided by a clinician. In some embodiments, generating the indication of the patient's ability to participate in the shared decision making process further comprises comparing the first score and the second score to identify whether there was a change in a confidence level of the patient. In some embodiments, comparing the first score and the second score comprises determining a difference between the first score and the second score. In some embodiments, the method further comprises presenting the indication of the patient's ability to participate in the shared decision making process to a clinician.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 is a schematic of an exemplary system that assesses a patient's ability to participate in shared decision making with a clinician, according to some embodiments.

FIG. 2 is a flowchart of an exemplary method for assessing a patient's ability to participate in shared decision making with a clinician, according to some embodiments.

FIG. 3 is an exemplary screenshot for accessing a patient's profile, according to some embodiments.

FIG. 4 is an exemplary log-in screenshot to access a patient profile, according to some embodiments.

FIGS. 5A and 5B are exemplary screenshots of a homepage of a patient's profile, according to some embodiments.

FIG. 6 is an exemplary screenshot of a questionnaire, according to some embodiments.

FIGS. 7A and 7B are exemplary screenshots of educational content, according to some embodiments.

FIG. 8 is an exemplary screenshot of a patient's medications, according to some embodiments.

FIG. 9 is an exemplary screenshot of clinician information, according to some embodiments.

FIG. 10 is an exemplary screenshot of hospital information, according to some embodiments.

FIG. 11 is an exemplary screenshot of physical therapy exercises, according to some embodiments.

FIG. 12 is an exemplary screenshot of resource information, according to some embodiments.

FIG. 13 is an exemplary screenshot of educational content advising a patient on how to maintain or improve his health and well-being, according to some embodiments.

FIG. 14 is an exemplary screenshot of messages and action items in a patient profile, according to some embodiments.

FIG. 15 is an exemplary screenshot of a survey for a patient to provide feedback on his experience with a healthcare provider, according to some embodiments.

FIG. 16 is a block diagram of an exemplary computer system on which some embodiments may be implemented.

### DETAILED DESCRIPTION

Aspects of the present application relate to techniques for assessing a patient's ability to participate in a shared decision making process with a clinician. In a shared decision making process, a patient and a clinician assess the patient's health and possible actions to take including treatment options and together decide what action, if any, to take. Since different patients vary in their personal preferences and values, a shared decision making process can take into account these individual differences by having the patient engaged in the decision-making process himself. The patient's knowledge about her medical condition and/or treatment options associated with the medical condition can impact the effectiveness of the shared decision making process. A patient informed about her medical condition may be better positioned to engage in a more effective conversation with her clinician and may achieve an outcome that aligns with her personal preferences and values, including those related to her health and lifestyle.

Patients can vary in their level of knowledge and/or their level of confidence in their knowledge regarding their medical condition, which can impact the effectiveness of the shared decision making process. A patient who is more informed about her medical condition and has a high confidence level in her knowledge may more effectively participate in the shared decision making process than a less informed patient who has a low confidence level. By assessing the patient's level of confidence in understanding her medical condition and/or treatment options before a clinician engages in the shared decision making process with the patient, the clinician can achieve a better understanding of the patient's capacity to participate in shared decision making.

Applicants have appreciated that an assessment can be used to evaluate the patient's confidence in understanding her medical condition and/or treatment options. The assessment can be in the form of a questionnaire that includes questions prompting the patient to self-assess her own confidence level of her medical condition and/or treatment options. A score can be generated from the responses a patient provides in responding to the questionnaire. The score may provide an indication of the patient's level of confidence in understanding her medical condition and/or treatment options. A clinician may determine from the score whether the patient has the ability to participate in a shared decision making process.

The assessment can be used to evaluate the extent to which a patient's level of confidence in understanding her medical condition improves after consuming educational content (e.g., videos, documents, presentations, audio content) related to her medical condition. A patient may complete the assessment prior to viewing educational content relevant to her medical condition to obtain a pre-content score. The patient may complete the assessment a second time, after viewing the educational content, to obtain a post-content score. The pre-content score and the post-content score may provide an indication of the patient's ability to participate in a shared decision making process. By comparing the pre-content and post-content scores, an impact of the patient viewing the educational content on her confidence and/or knowledge may be determined. A difference in the pre-content and post-content scores may indicate a change in the patient's confidence and/or knowledge. A post-score that is higher than the pre-score may indicate that the patient's confidence and/or knowledge has improved upon viewing the educational content. A clinician may assess the ability of the patient to participate in shared decision making based on the pre-content and post-content scores. In some embodiments, an indication that the patient is able to participate in shared decision making may be determined by comparing a difference between the pre-content and post-content scores to a threshold value and determining whether the difference is above the threshold value. A difference between the pre-content and post-content scores that is above the threshold value may indicate that the patient has the ability to effectively participate in shared decision making. While a difference between the pre-content and post-content scores that is below the threshold value may indicate that a shared decision making process with the patient is likely to be ineffective. In some embodiments, a clinician may assess the ability of the patient to participate in shared decision making based on the post-content score. In such embodiments, an indication that the patient is able to participate in shared decision making may be determined by comparing the post-content score to a threshold value and determining whether the post-content score is above the threshold value. A post-content score above the threshold value may indicate that a shared decision making process with the patient is likely to be effective. While a post-content score below the threshold value may indicate that the shared decision making process is likely to be ineffective.

The aspects and embodiments described above, as well as additional aspects and embodiments, are described further below. These aspects and/or embodiments may be used individually, all together, or in any combination of two or more, as the application is not limited in this respect.

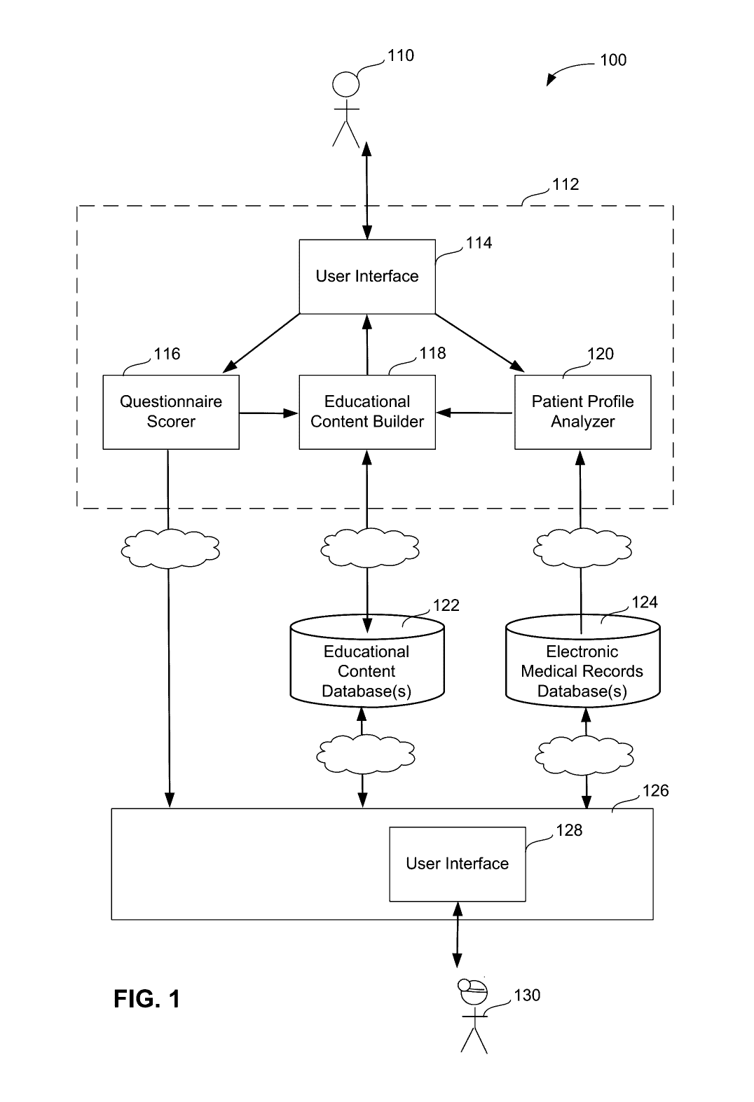

FIG. 1 illustrates an exemplary embodiment of system 100 for assessing the ability of a patient to participate in a shared decision making process with a clinician. In some embodiments, system 100 may assess a patient's level of confidence of her medical condition. In some embodiments, system 100 may assess a patient's level of confidence in treatment options for one or more medical conditions. System 100 includes assessment system 112 that is accessible by patient 110 via user interface 114, which is a component of and/or in communication with assessment system 112. System 100 includes computing device 126 that is accessible by clinician 130 via user interface 128. Computing device 126 may be, for example, a smartphone, tablet, or other mobile device. System 100 also includes educational content database(s) 122 and electronic medical records database(s) 124, which may be accessible by assessment system 112 and/or computing device 126. Using techniques described herein, system 100 may assess the ability of patient 110 to participate in a shared decision making process with clinician 130. System 100 may receive input from patient 110 indicative of responses to questions in a questionnaire and generating an indication based on the received input. In some embodiments, system 100 may receive input from patient 110, both before and after presenting educational content to patient 110 and generate the indication based on the received input.

As depicted, exemplary assessment system 112 includes questionnaire scorer 116, educational content builder 118, and patient profile analyzer 120. Each of these processing components of assessment system 112 may be implemented in software, hardware, or a combination of software and hardware. Components implemented in software may comprise sets of processor-executable instructions that may be executed by one or more processors of assessment system 112 to perform the functionality described herein. Any combination of questionnaire scorer 116, educational content builder 118, and patient profile analyzer 120 may be implemented on one or more separate machines, or parts of any or all of the components may be implemented across multiple machines in a distributed fashion and/or in various combinations.

Assessment system 112 may present to patient 110 an assessment in the form of a questionnaire. The questionnaire may include questions can be used in assessing multiple patients regardless of their medical condition. In some embodiments, the questionnaire may include questions that are nonspecific to the type of medical condition of the patient. Such questions may be suitable for patients having different types of medical conditions and may allow for the same questionnaire to be used for multiple patients. In some embodiments, the questionnaire may include questions specific to the type of medical condition of the patient. Any suitable number of questions may be included in the questionnaire. In some embodiments, the number of questions may be limited to below a threshold amount (e.g., 10, 15, 20) to sufficiently assess the patient's ability to participate in shared decision making while reducing the amount of time the patient spends on the questionnaire. The questionnaire can include itemized answer options for the patient to select in answering a question, which may ease the ability of the patient in responding to the questions on the questionnaire. The itemized answer options may be in the form of a scale (e.g., 1-5), multiple selections (e.g., yes/no selections), or any other suitable form.

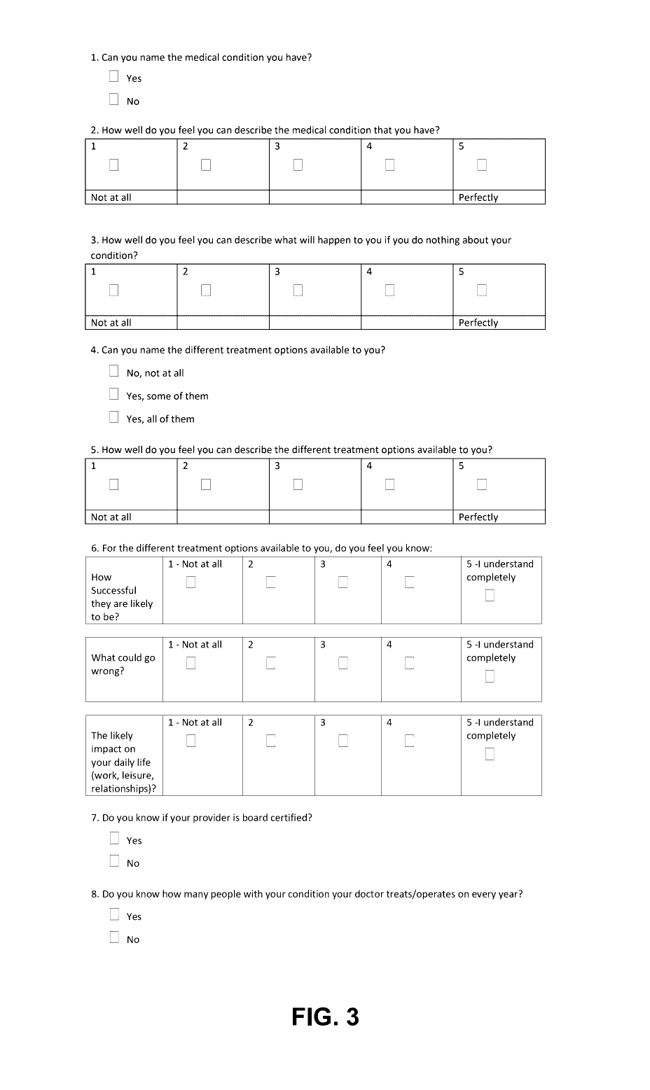

An exemplary questionnaire is shown in FIG. 3. Questions in the exemplary questionnaire include “How well do you feel you can describe the medical condition that you have?” and “How well do you think you can describe the different treatment options available to you?” The exemplary questionnaire shown in FIG. 3 also includes itemized answer options for each of the eight questions. The format of the itemized answer options allow a patient to provide input by selecting one of the answer options for each question. It should be appreciated that in some embodiments a questionnaire may have one or more questions where a patient can provide input by selecting more than one answer option. The format of the itemized answer options can vary among the questions, such as in the exemplary questionnaire shown in FIG. 3. For example, question 1 states “Can you name the medical condition you have?” and provides “Yes” and “No” as the two answer options. Other questions provide a scale of different numbers (e.g., 1, 2, 3, 4, 5) which indicate a range of different responses to the question. In some instances, a value of “1” corresponds to a response of “Not at all” and a value of “5” may corresponds to a response of “Perfectly” or “I understand completely.” Values “2,” “3,” and “4” may correspond to different levels of confidence between these two responses. For example, question 5 states “How well do you feel you can describe the different treatment options available to you?” and provides a scale of 1 to 5 with 1 corresponding to an answer of “Not at all” and 5 corresponding to “Perfectly”.

Patient 110 may provide information to generate a patient profile in assessment system 112. The patient profile may be generated when the patient first accesses assessment system 112 such as by logging into the assessment system. The patient profile may include identification information specific to patient 110 (e.g., name, age, birth date, contact information, healthcare provider). The patient profile may be formed by providing information via user interface 114. User interface 114 may be a display, touch screen, or any other suitable user interface. In some embodiments, assessment system 112 may include a mobile device (e.g., phone, tablet) which includes user interface 114. The mobile device may allow patient 110 to easily access content associated with her profile, including the questionnaire and educational content. Patient 110 may log into her profile to access content related to her health including his conditions, medications, medical record, and medical tests.

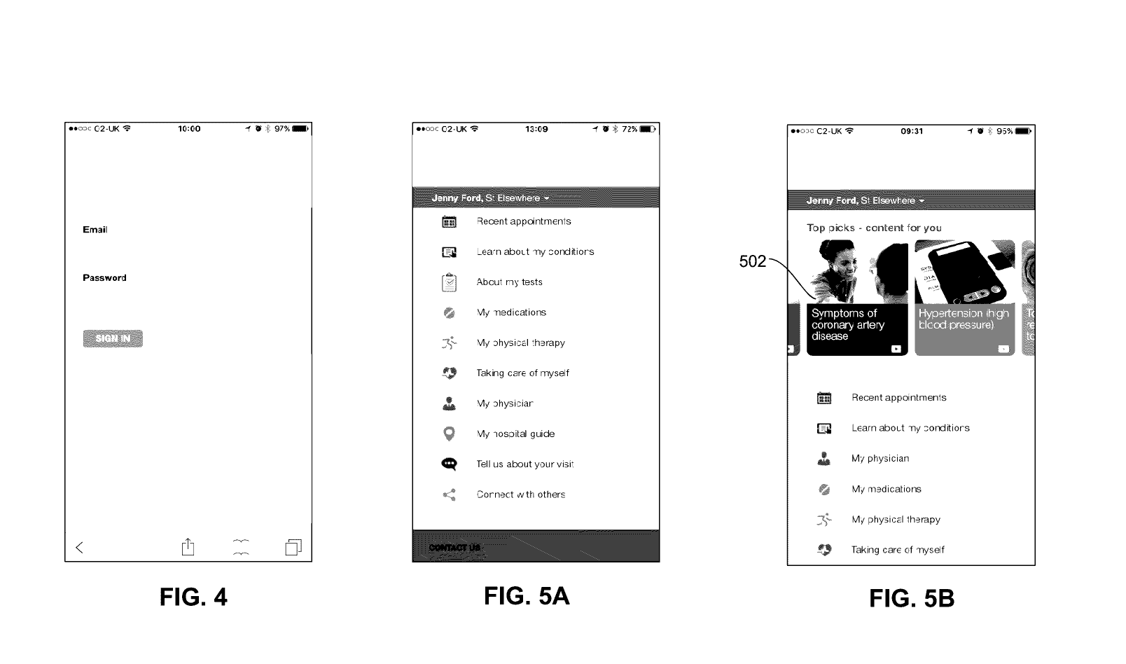

Any suitable criteria (e.g., email address, user name, password) may be used for a patient to access his profile. FIG. 4 depicts an exemplary log-in screenshot of a graphical user interface to access a patient profile where the patient provides an email address and password. A homepage of the patient profile may provide links to additional healthcare information associated with the patient. The homepage may include links to educational content related to a medical condition of the patient. FIG. 5A depicts an exemplary homepage screenshot of a graphical user interface of a patient's profile. As shown in FIG. 5A, the homepage includes links to access information related to the patient's recent appointments, medical conditions, medical tests, medications, physical therapy, physician, and hospital. A patient may select a link to display information associated with the link. For example, a patient may select “My medications” to access information related to his current medications and/or medication history. FIG. 5B depicts an exemplary homepage screenshot of a graphical user interface of a patient's profile that includes icons that link to educational content. A patient may select an icon to access educational content associated with the icon. In some embodiments, the icons associated with education content may be displayed based on patient information associated with the patient profile. Patient information may include a medical condition of the patient, medications that the patient is taking, and medical records associated with the patient. For example, icon 502 says “Symptoms of coronary artery disease” may have been selected to be displayed in the patient's profile based on patient information indicating that the patient may be diagnosed or may be at risk of having coronary artery disease. A patient may access educational information associated with icon 502 to view information about symptoms of coronary artery disease, which may be a medical condition specific to the patient. In this manner, the patient profile may include educational information tailored to the patient's personal medical conditions. The patient profile may store information associated with a patient over time. The patient may access information stored associated with his profile that was collected at different points in time, which may allow the patient to track his own individual progress.

Patient 110 may access a questionnaire or other form of assessment via user interface 114, which may present the questions and associated itemized answer options in the questionnaire. In some embodiments, the patient may be prompted to answer the questions in the questionnaire for a specific medical condition. The itemized answers may facilitate the ability of the patient to provide the input by touching one area of the display rather than having to enter in text through a keyboard. In this manner, the patient may be able to provide answers to the questions on the questionnaire in a short period of time (e.g., 2 minutes). In some embodiments, patient 110 may access a questionnaire through his personal profile for assessment system 112. Answers provided by patient 110 in response to the questions in the questionnaire may be stored in association with the patient's profile and used to identify educational content to present to patient 110. Responses to questions answered by a patient may be stored in association with the patient's profile. If the patient logs out or is timed out of his profile, then the responses provided by the patient are saved and the patient can return to his profile to answer any unanswered questions at a later time.

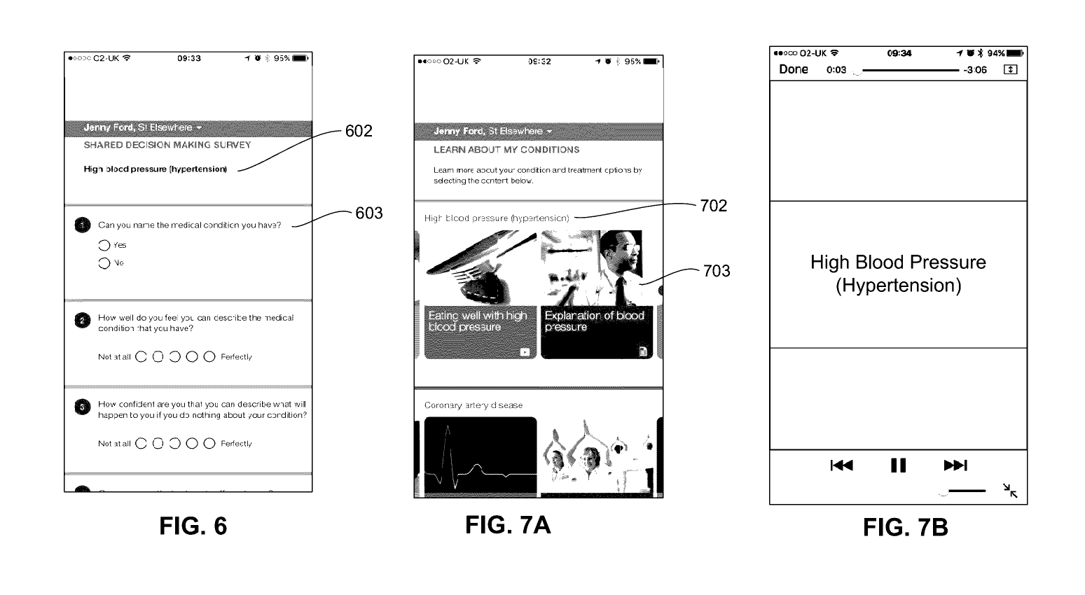

In some embodiments, the questionnaire may include information identifying one or more medical conditions associated with the patient's profile. A user may be prompted to provide responses to questions in the questionnaire related to the one or more medical conditions. The information identifying one or more medical conditions may vary among profiles for different patients while the questions in the questionnaire remain the same. In this manner, the same questions may be used for multiple patients that have different medical conditions by prompting the particular medical conditions associated with individual patients. FIG. 6 depicts a screenshot of a graphical user interface of a questionnaire. Region 602 identifies a medical condition associated with the patient, which may prompt the patient to answer the questions in the questionnaire, such as shown in region 603, with the medical condition of region 602 in mind. As shown in FIG. 6, region 602 identifies “High blood pressure (hypertension)” as the patient's medical condition, which may prompt the patient to answer the questions for this medical condition. The medical condition displayed in region 602 may vary among individual patients such that region 602 identifies a medical condition for a patient associated with the patient's profile.

Responses provided by the patient may be used to generate an indication of the patient's ability to participate in a shared decision making process with a clinician. Assessment system 112 includes questionnaire scorer 116, which may generate a score based on the patient's responses. Questionnaire scorer 116 may aggregate the responses to some or all of the questions in the questionnaire into a score by associating answer options to certain values and combining the values associated with the answers provided by the patient. The resulting score may provide an indication of the patient's confidence level in understanding her medical condition and/or options to treat her medical condition. In some embodiments, questions may be given equal weight in determining the score such that responses to each question in the questionnaire contribute equally to the score. In some embodiments, questions may be weighted such that answers to the questions contribute unequally to the resulting score for the questionnaire. The questions may be weighted based on the patient's preferences. A question representative of something that the patient values more may be weighted more than a question representative of something less valued by the patient. In this manner, the score may be tailored to individual patients to account for their personal preferences. For example, the question “Do you know how many people you're your condition your doctor treats/operates on every year?” may have a higher weight to account for the patient's preference of having a clinician with this type of experience. Some patients may not have a strong preference about having a clinician with this type of experience and the question may have a lower weighted value to account for this preference. Questionnaire scorer 116 may transmit data indicating the patient's score to computing device 126. Clinician 130 may access the patient's score via user interface 128, and the patient's score may be used to determine whether the patient has the ability to participate in shared decision making.

Some embodiments relate to techniques for presenting educational content to a patient where the educational content may depend on patient information associated with the patient including responses provided by the patient to one or more questions in a questionnaire and/or a patient profile associated with the patient. As depicted in FIG. 1, assessment system 112 may include educational content builder 118, which may identify educational content to present to patient 110. Patient 110 may access educational content via user interface 114 of assessment system 112. Educational content builder 118 may retrieve educational content from one or more educational content databases 122. Educational content database(s) 122 may include documents, video files, audio files, presentations, and any other information having any suitable file format. In some embodiments, educational content may include learning aids, such as integrated quizzes that test the patient's knowledge of the educational content. Educational content database(s) 122 may be developed by any suitable person or entity (e.g., clinician, hospital, research center, healthcare association). The data in an educational content database may be organized such that the educational content can be searched by a medical condition (e.g., keyword search). For example, the data in an educational content database may be stored in a relational database structure that stores relationships between items such as different medical conditions and associated educational content. Educational content builder 118 may construct a query and transmit the query to educational content database(s) 122 and receive educational content in response to the query. The query may include a search term or phrase descriptive of a medical condition. In some embodiments, the educational content in an educational content database may be specific to a type of medical condition, such as a medical condition of patient 110. In this manner, individual educational content databases may be associated with different types of medical conditions. Educational content builder 118 may identify one or more educational content databases 112 for one or more medical conditions associated with the patient 110 and retrieve educational content from the identified educational content databases 112.

Some embodiments relate to one or more educational content databases 122 specific to a certain individual or group or people (e.g. hospital, healthcare provider, employer). The individual or group may generate an educational content database by selecting the educational content to be stored in the database. The individual or group may modify and/or delete information in the educational content database. In this manner, the individual or group may specify the information and/or types of information to present to a patient. As shown in FIG. 1, clinician 130 may access educational content database(s) 122 via user interface 128 of computing device 126 to modify, delete, and/or add information stored in one or more educational content databases 122. Clinician 130 may be a healthcare provider to patient 110 and can tailor the educational content accessible to patient 110. In this manner, clinician 130 may identify educational content specific to patient 110 and/or a medical condition of patient 110 that clinician 130 would like patient 110 to view.

Data indicative of the questionnaire responses provided by patient 110 may be received by educational content builder 118. Educational content builder 118 may use the responses to construct a query for educational content database(s) 122. Educational content may be retrieved and/or selected based on one or more of a patient's answers to the questionnaire. If a patient's response indicates a lower level of confidence in a topic area related to the patient's medical condition, then educational content builder 118 may select educational content related to the topic area. For example, a patient's responses to a questionnaire may indicate a lower level of confidence in understanding treatment options for a medical condition than the medical condition itself. Educational content builder 118 may select educational content associated with the treatment options as possible content to present to the patient. In some embodiments, educational content builder 118 may receive a score generated by questionnaire scorer 116. Educational content builder 118 may construct a query based on the score provided by questionnaire scorer 116.

Educational content builder 118 may retrieve educational content based on information stored in a patient profile. Patient 110 may log into her patient profile via user interface 114. Patient profile analyzer 120 may analyze data stored in the patient profile and transmit information associated with a medical condition of patient 110 to educational content builder 118, which may use the information to retrieve and/or select educational content. Patient profile analyzer 120 may receive information indicative of the patient's medical condition from electronic medical records database(s) 124. An electronic medical record may include information about a patient's medical history, condition, and/or treatments. Information stored in the electronic medical record may be added, deleted, and/or modified by clinician 130 or other healthcare provider via user interface 128 of computing device 126. Identification information (e.g., name, birth date, social security number, medical insurance number, patient number) stored in a patient profile for patient 110 may be used to access the electronic medical record for patient 110 by patient profile analyzer 120. Patient profile analyzer 120 may receive data indicating information about a medical condition of patient 110 (e.g., clinical code, medical condition category) and transmit the data to educational content builder 118. In this manner, information stored in an electronic medical record of patient 110 may be used to generate and/or select educational content to present to patient 110.

Clinician 130 may include a clinical code that identifies a medical condition of patient 110 in an electronic medical record for patient 110. The clinical code may be stored in electronic medical records database(s) 124. Patient profiler analyzer 120 may access the clinical code stored in the electronic medical record by information that identifies patient 110 (e.g., patient's name, birthdate) and transmit the clinical code to educational content builder 118. Educational content builder 118 may select educational content in accordance with the clinical code.

In some embodiments, educational content builder 118 may identify educational content based on one or more preferences of patient 110. Preferences of patient 110 may include a format type (e.g., video, audio, text) of educational content that the patient prefers to receive. Such preferences of patient 110 may be stored in association with the patient's profile. Educational content builder 118 may access one or more patient preferences and identify educational content to present to patient 110 based on the one or more patient preferences. For example, patient 110 may prefer to receive educational content having a video format, which may be indicated in the patient's profile. Educational content builder 118 may retrieve educational content from educational content database(s) 122 where a portion or all of the retrieved educational content has a video format.

Educational content received and/or selected by educational content builder 118 may be presented to patient 110 via user interface 114. The educational content may be stored in a patient profile for patient 110 such that patient 110 may access the educational content by logging into her patient profile. One or more medical conditions may be listed in a patient's profile, and educational content associated with the one or more medical conditions may be presented to the patient. FIG. 7A depicts an exemplary screenshot of a graphical user interface that presents educational content related to a patient's medical conditions. As shown in FIG. 7A, region 702 indicates a patient's medical condition as “High blood pressure (hypertension) and region 703 indicates a link to educational content as “Explanation of blood pressure.” A patient can access the content associated with the link by opening or clicking on the link. FIG. 7B depicts an exemplary screenshot of a video titled “High Blood Pressure (Hypertension),” which can be accessed by a patient. A patient may stop, pause, and/or restart presentation of educational content, such as the video shown in FIG. 7B, at any moment. A patient may return to a paused location in an educational material when he logs into his patient profile a subsequent time.

In some embodiments, clinician 130 may monitor the educational content selected by educational content builder 118 and presented to patient 110. Clinician 130 may monitor progress by patient 110 in viewing certain educational content and/or track statistics related to patient 110 viewing the educational content (e.g., time spent viewing a particular document, whether a video has been viewed). This information may be used by clinician 130 to assess the patient's confidence level in understanding a medical condition and ability to participate in a shared decision making process. In some embodiments, clinician 130 may receive an indication that patient 110 has partially or completely viewed a piece of educational content. Clinician 130 may receive the indication, such as via user interface 128, in any suitable format including a text message, email, and voice message.

Some embodiments relate to obtaining responses to a questionnaire before and after a patient accesses educational content. Over a first time duration, the patient may provide a first set of responses to the questionnaire, which may be used to generate a pre-content questionnaire score. Educational content related to a medical condition and/or treatment options for the medical condition may be presented to the patient. Over a second time duration, the patient may provide a second set of responses to the questionnaire, which may be used to generate a post-content questionnaire score. The pre-content and post-content scores may be used to determine the patient's ability to participate in shared decision making. By using the same questionnaire to assess the patient before and after she views the educational content, the educational content can be evaluated. Accordingly, some embodiments relate to evaluating the effectiveness of certain educational content in improving the ability of a patient to participate in shared decision making. For example, pre-content scores and post-content scores that are similar may indicate little or no change in a patient's confidence level from viewing the educational content and may indicate to a clinician or healthcare provider that the educational content as ineffective in educating the patient about his medical condition. In some embodiments, the pre-content and post-content scores may indicate to the patient the extent to which he has gained an understanding of his medical condition and/or treatment options from viewing the educational content. The pre-content and post-content scores may be used to generate an indication of whether the patient is suitably informed to participate in a shared decision making process with his clinician.

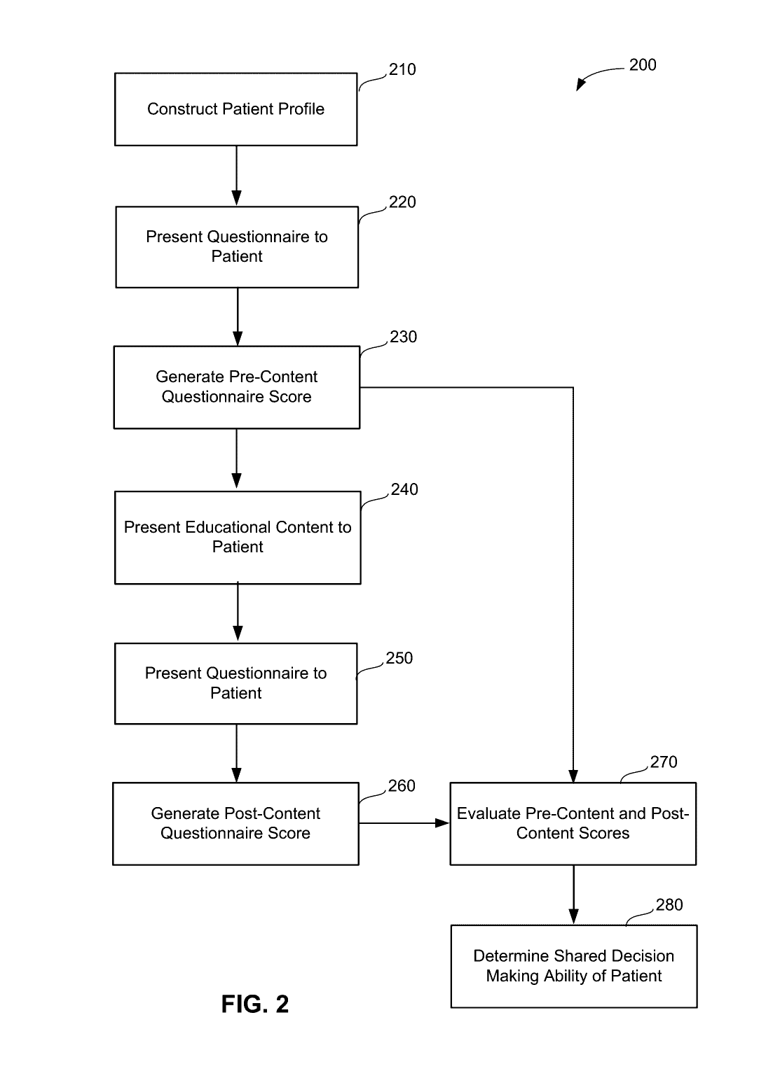

FIG. 2 depicts an exemplary method for assessing a patient's ability to participate in shared decision making using the techniques described herein, including the system described in FIG. 1. Method 200 begins at step 210 where a patient profile is constructed, such as by assessment system 100. Information identifying the patient, questionnaire results, and educational content related to the patient's medical condition(s) may be stored in the patient profile. A questionnaire is presented to the patient by step 220 of method 200, such as by user interface 114 of assessment system 112. A first set of responses to questions in the questionnaire may be received by user interface 114 over a first time duration. The first set of responses may be used to generate a pre-content questionnaire score, such as by questionnaire scorer 116 of assessment system 112, by step 230 of method 200. Educational content is selected, such as by educational content builder 118, and presented to a patient, such as by user interface 114, by step 240. The questionnaire is presented to the patient by step 250 of method 200, and a second set of responses to the questions in the questionnaire may be received by user interface 114 over a second time duration. In some embodiments, step 250 may occur only after a predetermined amount of educational content is presented to the patient. The second set of responses may be used to generate a post-content questionnaire score, such as by questionnaire scorer 116 of assessment system 112, by step 260 of method 200. Evaluation of the pre-content and post-content scores from steps 230 and 260, respectively, may occur by step 270 of method 200. The evaluation of the pre-content and post-content scores of step 270 may include generating a combined score based on the pre-content and post-content scores. In some embodiments, the combined score may be a difference between the pre-content and post-content scores. The combined score may be based on a range of numbers (e.g., 0-100) such that numbers along the range indicate different levels of confidence by the patient. Determination of the ability of the patient to participate in shared decision making may occur by step 280 of method 200. Step 280 may include determining the patient's ability to participate in shared decision making based on the evaluation of the pre-content and post-content scores of step 270. In some embodiments, step 280 may be performed by a clinician. In some embodiments, the evaluation of the pre-content and post-content scores of step 270 may generate a composite score. The composite score may be compared to a threshold value to determine the patient's ability. For example, if the composite score is above the threshold value, then the patient may be determined to be able to participate in a shared decision making process.

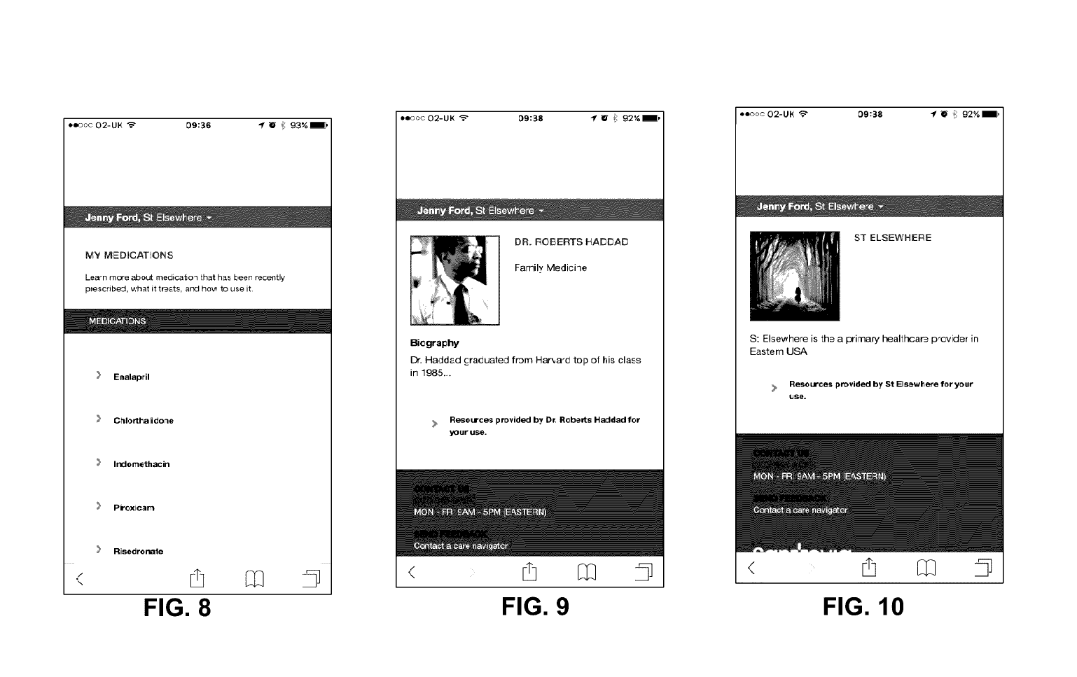

Additional information may be provided in a patient profile. FIGS. 8-15 depict exemplary screenshots that may be associated with a patient profile. In some embodiments, a patient may view information related to his medications in his patient profile, such as shown in FIG. 8. The medical information may be accessed by the patient selecting a link on a homepage of the patient's profile, such as the link for “My medications” shown in FIG. 5A. The medication information may include information on what type of symptoms and/or medical condition a medication is used to treat. The medical information may include details on how to use one or more medications to treat a symptom and/or medical condition. Such details may include dosage information, duration of time the patient is to take the medication, an indicator for when the patient should stop taking the medication, whether the patient can obtain a refill on their prescription, and any other suitable information associated with one or more medications associated with the patient.

In some embodiments, a patient may view information related to his doctor or clinician in his patient profile, such as shown in FIG. 9. The clinician information may include the clinician's name, specialty (e.g., family medicine, internal medicine, geriatrics), educational background, contact information, and resources provided by the clinician. The clinician information may be accessed by the patient selecting a link on a homepage of the patient's profile, such as the link for “My physician” shown in FIG. 5A.

In some embodiments, a patient may view information associated with his hospital in his patient profile, as shown in FIG. 10. The hospital information may include the name of the hospital, location of the hospital, contact information for the hospital, and resources provided by the hospital. The hospital information may be accessed by the patient selecting a link on a homepage of the patient's profile, such as the link for “My hospital guide” shown in FIG. 5A.

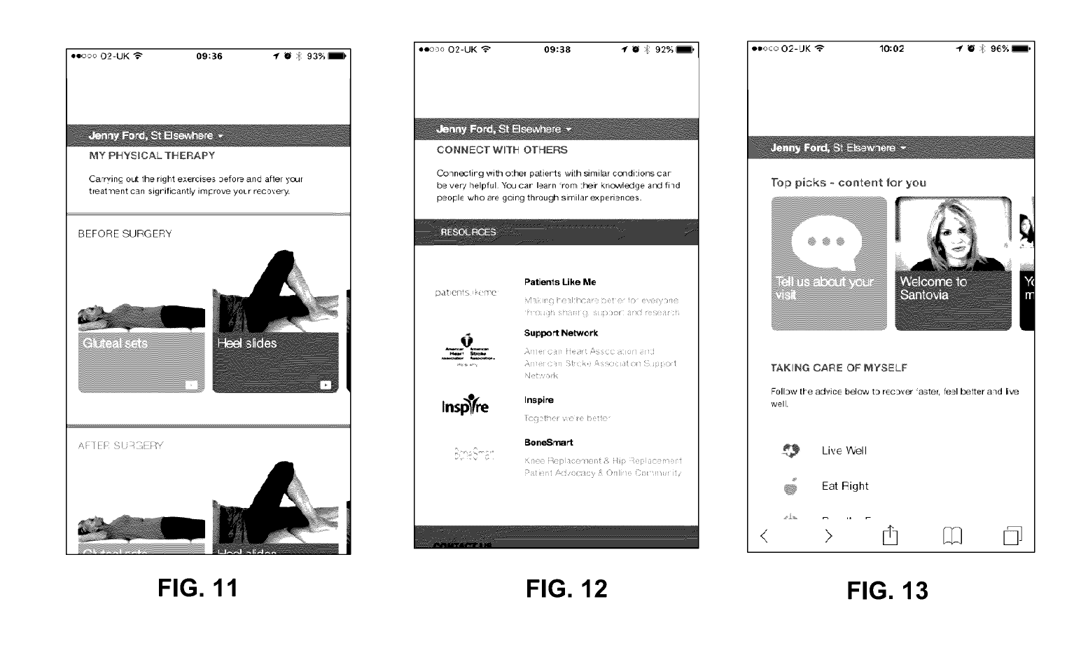

In some embodiments, a patient may view information about physical therapy to perform, as shown in FIG. 11. The physical therapy information may include educational videos that demonstrate recommended exercises based on a procedure and/or treatment performed on the patient. The recommended exercises may improve the patient's recovery process. The physical therapy information may include recommended physical therapy exercises for the patient to perform before and/or after receiving a procedure and/or treatment. The physical therapy information may be accessed by the patient selecting a link on a homepage of the patient's profile, such as the link for “My physical therapy” shown in FIG. 5A.

In some embodiments, a patient may view information about online communities that the patient may connect with to communicate with others, as shown in FIG. 12. The community information may include one or more online communities (e.g., support groups) tailored to other individuals experiencing the same or similar medical condition as the patient. The community information may be accessed by the patient selecting a link on a homepage of the patient's profile, such as the link “Connect with others” shown in FIG. 5A.

In some embodiments, a patient may view information about how to maintain or improve one's health and well-being, as shown in FIG. 13. The health information may include one or more resources for advice on how the patient can improve his recovery, his well-being, and his eating habits. The health information may be accessed by the patient selecting a link on a homepage of the patient's profile, such as the link “Taking care of myself” shown in FIG. 5A.

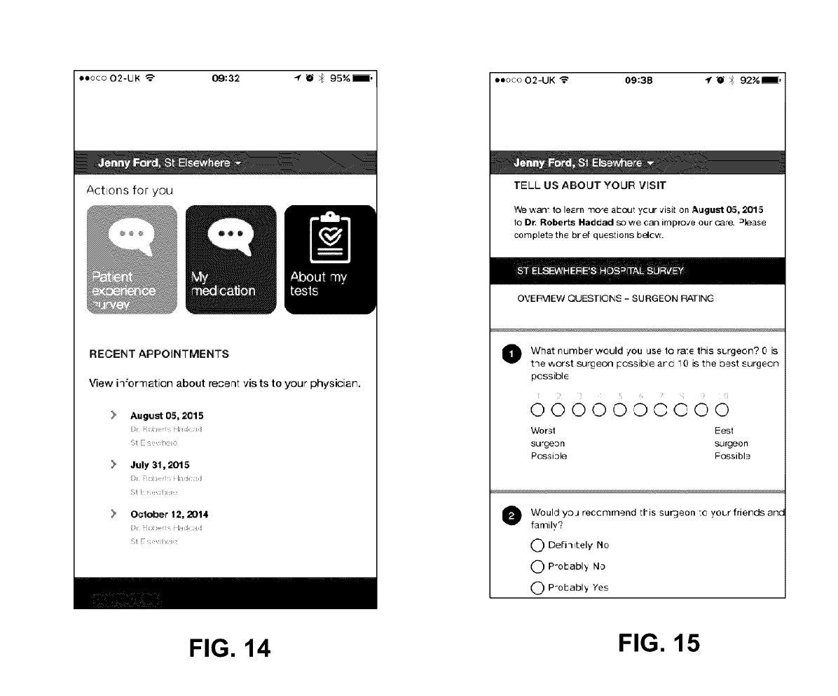

In some embodiments, a patient may view messages and or action items in his patient profile, such as shown in FIG. 14. The message information may include details related to one or more appointments with a clinician including date, clinician's name, and hospital name. The message information may include links to information about medications prescribed to the patient and/or information related to medical tests and/or treatments for the patient. The message information may be accessed by the patient selecting a link on a homepage of the patient's profile, such as the link “Recent appointments” shown in FIG. 5A.

In some embodiments, a patient may provide feedback to a healthcare provider through his patient profile, such as through a survey as shown in FIG. 15. The survey may include any suitable number of questions having any suitable format. The survey may be specific to a particular visit by the patient, the clinician, and/or the hospital. Results from the survey may be used to improve future patient experiences. The patient may access the survey through his patient profile, such as by selecting the link “Patient experience survey” shown in FIG. 14. In some embodiments, a survey for the patient to fill out may populate for each of the patient's appointments.

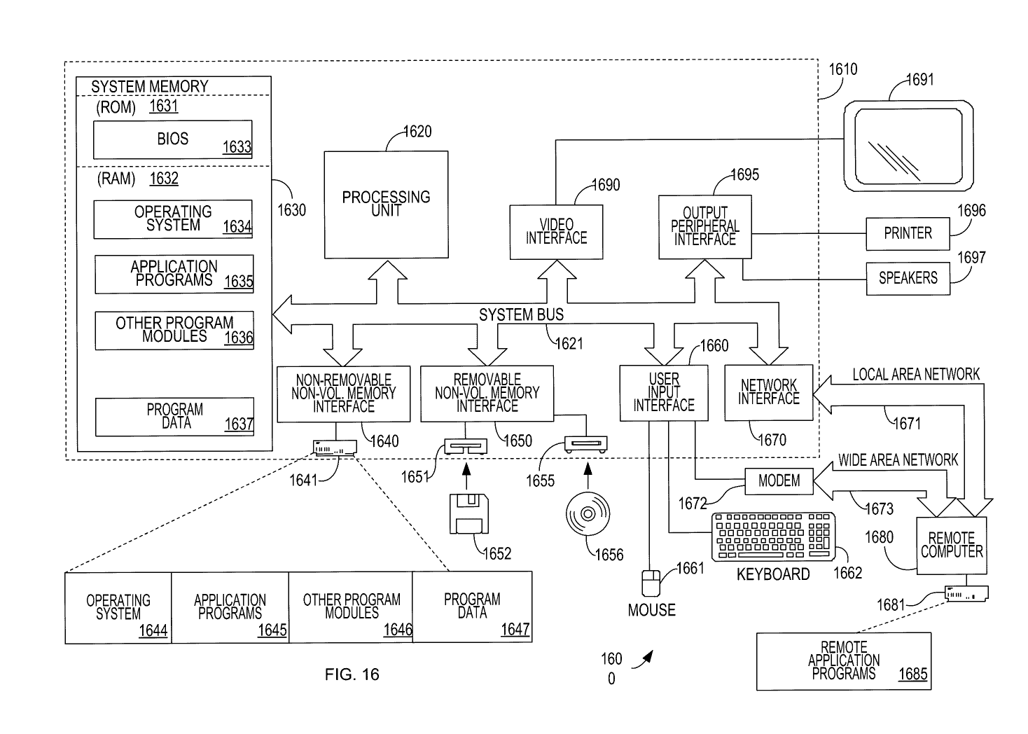

FIG. 16 illustrates an example of a suitable computing system environment 1600 on which the invention may be implemented. The computing system environment 1600 is only one example of a suitable computing environment and is not intended to suggest any limitation as to the scope of use or functionality of the invention. Neither should the computing environment 1600 be interpreted as having any dependency or requirement relating to any one or combination of components illustrated in the exemplary operating environment 1600.

The invention is operational with numerous other general purpose or special purpose computing system environments or configurations. Examples of well known computing systems, environments, and/or configurations that may be suitable for use with the embodiments include, but are not limited to, smartphones, tablets, any type of mobile device, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular data types. Embodiments also be practiced in distributed computing environments where tasks are performed by remote processing devices that are linked through a communications network. In a distributed computing environment, program modules may be located in both local and remote computer storage media including memory storage devices.

With reference to FIG. 16, an exemplary system for implementing the invention includes a computing device in the form of a computer 1610. Components of computer 1610 may include, but are not limited to, a processing unit 1620, a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1610 typically includes a variety of computer readable media. Computer readable media can be any available media that can be accessed by computer 1610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 16 illustrates operating system 1634, application programs 1635, other program modules 1636, and program data 1637.

The computer 1610 may also include other removable/non-removable, volatile/nonvolatile computer storage media. By way of example only, FIG. 16 illustrates a hard disk drive 1641 that reads from or writes to non-removable, nonvolatile magnetic media, a magnetic disk drive 1651 that reads from or writes to a removable, nonvolatile magnetic disk 1652, and an optical disk drive 1655 that reads from or writes to a removable, nonvolatile optical disk 1656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1641 is typically connected to the system bus 1621 through an non-removable memory interface such as interface 1640, and magnetic disk drive 1651 and optical disk drive 1655 are typically connected to the system bus 1621 by a removable memory interface, such as interface 1650.

The drives and their associated computer storage media discussed above and illustrated in FIG. 16, provide storage of computer readable instructions, data structures, program modules and other data for the computer 1610. In FIG. 16, for example, hard disk drive 1641 is illustrated as storing operating system 1644, application programs 1645, other program modules 1646, and program data 1647. Note that these components can either be the same as or different from operating system 1634, application programs 1635, other program modules 1636, and program data 1637. Operating system 1644, application programs 1645, other program modules 1646, and program data 1647 are given different numbers here to illustrate that, at a minimum, they are different copies. A user may enter commands and information into the computer 1610 through input devices such as a keyboard 1662 and pointing device 1661, commonly referred to as a mouse, trackball or touch pad. Other input devices (not shown) may include a microphone, joystick, game pad, satellite dish, scanner, or the like. These and other input devices are often connected to the processing unit 1620 through a user input interface 1660 that is coupled to the system bus, but may be connected by other interface and bus structures, such as a parallel port, game port or a universal serial bus (USB). A monitor 1691 or other type of display device is also connected to the system bus 1621 via an interface, such as a video interface 1690. In addition to the monitor, computers may also include other peripheral output devices such as speakers 1697 and printer 1696, which may be connected through a output peripheral interface 1695.

The computer 1610 may operate in a networked environment using logical connections to one or more remote computers, such as a remote computer 1680. The remote computer 1680 may be a personal computer, a server, a router, a network PC, a peer device or other common network node, and typically includes many or all of the elements described above relative to the computer 1610, although only a memory storage device 1681 has been illustrated in FIG. 16. The logical connections depicted in FIG. 16 include a local area network (LAN) 1671 and a wide area network (WAN) 1673, but may also include other networks. Such networking environments are commonplace in offices, enterprise-wide computer networks, intranets and the Internet.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. The modem 1672, which may be internal or external, may be connected to the system bus 1621 via the user input interface 1660, or other appropriate mechanism. In a networked environment, program modules depicted relative to the computer 1610, or portions thereof, may be stored in the remote memory storage device. By way of example, and not limitation, FIG. 16 illustrates remote application programs 1685 as residing on memory device 1681. It will be appreciated that the network connections shown are exemplary and other means of establishing a communications link between the computers may be used.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only.

What is claimed is:

1. A computer-implemented system for assessing the ability of a patient to participate in a shared decision making process with a clinician, the system comprising:
a user interface configured to:
receive, from the patient, user input indicative of a first set of responses to questions of a questionnaire over a first time duration;
present, to the patient, educational content associated with a medical condition of the patient; and
receive, from the patient, user input indicative of a second set of responses to questions of the questionnaire over a second time duration, wherein the second time duration occurs at a time after the educational content is presented; and
at least one processor configured to receive data indicative of the first and second set of responses; and
at least one storage medium storing processor-executable instructions that, when executed by the at least one processor, perform a method comprising:
generating a first score based on the first set of responses and a second score based on the second set of responses; and
generating an indication of the patient's ability to participate in the shared decision making process with a clinician based on the first and second scores.

2. The system of claim 1, wherein generating the indication of the patient's ability to participate in the shared decision making process further comprises determining a confidence level of the patient's understanding of the medical condition based at least in part on the patient's responses to at least a portion of the questions of the questionnaire.

3. The system of claim 1, wherein generating the indication of the patient's ability to participate in the shared decision making process further comprises determining a confidence level of the patient's understanding of treatment options for the medical condition based at least in part on the patient's responses to at least a portion of the questions of the questionnaire.

4. The system of claim 1, wherein the user interface is further configured to present itemized answer options for at least a portion of the questions of the questionnaire.

5. The system of claim 1, wherein the method further comprises selecting the educational content based on patient information associated with the patient.

6. The system of claim 5, wherein the patient information includes an electronic medical record of the patient.

7. The system of claim 1, wherein the method further comprises selecting the educational content based on information provided by a clinician via a second user interface.

8. The system of claim 1, wherein generating the indication of the patient's ability to participate in the shared decision making process further comprises comparing the first score and the second score to identify whether there was a change in a confidence level of the patient.

9. The system of claim 8, wherein comparing the first score and the second score comprises determining a difference between the first score and the second score.

10. The system of claim 1, wherein the system further comprises a second user interface configured to present the indication of the patient's ability to participate in the shared decision making process to a clinician.

11. A method for assessing the ability of a patient to participate in a shared decision making process with a clinician, the method comprising:
receiving, from the patient, user input indicative of a first set of responses to questions of a questionnaire over a first time duration;
presenting, to the patient, educational content associated with a medical condition of the patient;
receiving, from the patient, user input indicative of a second set of responses to questions of the questionnaire over a second time duration, wherein the second time duration occurs at a time after the educational content is presented;
generating a first score based on the first set of responses and a second score based on the second set of responses; and
generating an indication of the patient's ability to participate in the shared decision making process with a clinician based on the first and second scores.

12. The method of claim 11, wherein generating the indication of the patient's ability to participate in the shared decision making process further comprises determining a confidence level of the patient's understanding of the medical condition based at least in part on the patient's responses to at least a portion of the questions of the questionnaire.

13. The method of claim 11, wherein generating the indication of the patient's ability to participate in the shared decision making process further comprises determining a confidence level of the patient's understanding of treatment options for the medical condition based at least in part on the patient's responses to at least a portion of the questions of the questionnaire.

14. The method of claim 11, wherein the method further comprises presenting itemized answer options for at least a portion of the questions of the questionnaire.

15. The method of claim 11, wherein the method further comprises selecting the educational content based on patient information associated with the patient.

16. The method of claim 15, wherein the patient information includes an electronic medical record of the patient.

17. The method of claim 11, wherein the method further comprises selecting the educational content based on information provided by a clinician.

18. The method of claim 11, wherein generating the indication of the patient's ability to participate in the shared decision making process further comprises comparing the first score and the second score to identify whether there was a change in a confidence level of the patient.

19. The method of claim 18, wherein comparing the first score and the second score comprises determining a difference between the first score and the second score.

20. The method of claim 11, wherein the method further comprises presenting the indication of the patient's ability to participate in the shared decision making process to a clinician.
